(19) United States
(12) Patent Application Publication
(10) Pub. No.: US 2018/0134535 A1
(43) Pub. Date: May 17, 2018

(54) APPARATUS AND METHOD FOR EMPTYING CONTAINERS WITH PERFORATION DEVICE

(71) Applicant: KRONES AG, Neutraubling (DE)

(72) Inventors: Ute John-Unterburger, Suenching (DE); Guenter Frankenberger, Koefering (DE); Jochen Krueger, Hagelstadt (DE); Christian Hajek, Ergolding (DE)

(21) Appl. No.: 15/567,647

(22) PCT Filed: Apr. 21, 2016
(86) PCT No.: PCT/EP2016/058860

§ 371 Date: Oct. 19, 2017

(30) Foreign Application Priority Data
Apr. 21, 2015 (DE) 10 2015 106 128.7

(51) Int. Cl. B67B 7/00

(52) U.S. Cl. CPC B67B 7/24

(57) ABSTRACT

Apparatus for emptying containers and in particular plastic containers with a first holding device which is suitable and intended for holding a first section of the container, with a second holding device which is suitable and intended for holding a second section of the container, wherein the first holding device and the second holding device are movable with respect to one another in order to compress the container located between these holding devices, and with a removal device in order to remove liquid from the container via a mouth thereof. According to the invention the apparatus has a perforation device which perforates at least a wall region of the container.

The present invention relates to an apparatus and a method for emptying containers. Such apparatus and methods have been known for a long time from the prior art. The applicant for the present patent application has recently developed an apparatus in which containers and in particular plastic containers are emptied by pressing two die elements together. In addition to this apparatus a special container has also been developed which can be emptied by pushing a mouth region of the container into a main body of the container, and in this way the volume of the container can be minimised.

Some of these containers are disposable containers. However, there is no guarantee or assurance that the container is actually used only one single time. Although there are solutions which prevent a tap pipe or a closure of the container from being used again, however, it would be possible to remove this closure or the tap line from the container and to use the container itself again with a new closure and a new tap pipe or only with a new tap pipe. Thus it would be possible that the container is pierced after tapping, but only in its closure, which could be replaced after the tapping in order to use the container again.

The original-closure and the disposable pipe are destroyed in normal use and cannot be used again. However, the described procedure for exchange of the closure or the tap pipe carries the risk that a container already hit during use is put to use as an allegedly pressure-stable container.

Containers which originally have already been filled once and have been emptied by means of a tap system could in principle be filled and used again. Firstly this is problematic from the point of view of hygiene. In addition, however, it may also be problematic from a safety-related aspect.

The greatest danger could be that the containers emptied by means of a tap system are mistaken for reusable plastic containers or at least are inadvertently inflated again, in particular by means of CO₂, I.e. that the containers are thus restored to their old shape. In particular the inflation of the containers with compressed gas, such as for example compressed air or CO₂, involves serious danger for the health or in even the life of persons in the immediate surroundings.

The containers can be weakened by the previous tapping process, since the plastic material, for example PET material, is deformed uncontrollably during tapping of the containers and thus stress whitening can occur in the material. During the tapping itself there is usually no danger, since here the pressure in the container is controlled and is reduced to a safe value.

However, when the container is inflated manually the pressure can be so high that the container can tear at weak points and in the worst case it can burst. The bursting pressure of the undamaged container is significantly higher than 10 bars, which as a rule cannot be reached without corresponding aids. However, a weakened container could already burst at 6-8 bars. In this case the enclosed gas volume of 20 litres expands abruptly to the 6 to 8 times the volume, which can lead to an enormous pressure wave. In this case parts of the container can even become life-threatening projectiles.

Various system are known from the prior art which are intended to ensure are that a container can only be used one single time. Such systems operate for example using an electronic chip which after the emptying of the container is changed in such a way that it cannot be used a second time in the emptying system. However, this requires relatively costly electronics. In addition it is not ensured that the container can also be reused for another purpose. In this case the functioning of the container is preserved in principle.

In addition optical elements, such as for example an imprint or barcode, can be mechanically destroyed or changed, but this likewise does not lead to destruction of the container.

The object of the present invention therefore is to provide an apparatus and a method which prevent the reuse of containers and in particular of plastic containers. These objects are achieved according to the invention by the subjects of the independent claims. Advantageous embodiments and modifications are the subject of the subordinate claims.

An apparatus according to the invention for emptying containers, and in particular plastic containers, has a first holding device which is suitable and intended for holding a first section of the container. Furthermore the apparatus has a second holding device which is suitable and intended for holding a second section of the container. In this case the first holding device and the second holding device are movable with respect to one another in order to compress the container located between these holding devices. Furthermore the apparatus has a removal device in order to remove liquid from the container via a mouth of the container.

According to the invention the apparatus has a perforation device which perforates at least a wall region of the container perforated. In particular the first section of the container and the second segment of the container are spaced apart from one another and in particular are completely separated from one another. A perforation is generally understood to be an opening and in particular a hole or a tear in the said wall.

It is therefore proposed that the container is perforated in at least one further region in particular after emptying, so that it is no longer suitable for further use. Thus in connection with the described apparatus for emptying the containers in particular at the end of the tapping process it is proposed that the container is destroyed in such a way that it can only be used one single time.

Possibilities for this are for example piercing, puncturing, perforating or punching the container, i.e. the container acquires a hole, so that when it is attempted to “re-inflate” It a pressure build-up in the container is no longer possible and therefore the risk of bursting (as a consequence of too high pressure in the container) no longer exists.

The perforation device is preferably suitable and intended for perforating the container while this container is still located on at least one holding device is located. In this way, after the emptying of the container the proposed perforation can be applied or introduced in one operation. At the end of the tapping process the container is empty and the pressure in the container is released. The container is still located in the tapping system or the apparatus or the rolled-in container is still located on the die or the second holding device. In this state the perforation device, which for example has a spike, a cutting blade or a drill bit, is pushed or turned through the container wall in order to destroy the container.

In a further advantageous embodiment the apparatus has a piercing device in order to puncture a container closure arranged on the container. This piercing device is advantageous a lance or more generally a tubular body through which liquid can be withdrawn. The perforation device in particular pierces into a wall region of the container and in particular in a region which is different from mouth section. This means that the container itself is destroyed.

In a further advantageous embodiment the perforation device has a mechanical perforation element which pierces through the wall of the container.

This may be for example—as described above—in a spike, a cutting blade or a drill bit. In this case a perforation is understood to be not necessarily only a hole produced for instance by a drill bit, but also a larger element which can be cut out for example by means of a blade.

However, in addition to a mechanical perforation element other means could also be used, for instance a laser which burns a hole or an element which melts the container wall. Thus for example an element heated by electrical current could be pushed through the wall of the container and could thus produce a hole therein.

In a further advantageous embodiment the first holding device receives a base section of the container and the second holding device receives a mouth region of the container. Thus the second holding device can preferably be constructed as a die, which during the compression of the container enters a region of the container in order to completely empty it.

In a further advantageous embodiment the first holding device is a base cup which receives the base section of the container and preferably completely surrounds it. These two holding devices are advantageously moved towards one another in particular in a longitudinal direction of the container in order in this way to empty the container.

Advantageously the second holding device is a die element, which in particular also receives a mouth region of the container.

In a further advantageous embodiment the perforation device is arranged on at least one of the two holding devices. Thus it would be possible for example for the perforation device to be provided on the second holding device or the die. Here for example has a spike, a cutting blade or a drill bit which is integrated into this second holding device or the die of the apparatus could be pushed or turned through the container wall in order to destroy the container. However, this spike, the blade or the drill bit can also be integrated in the first holding device, i.e. the base cup, also laterally on an arm. In a further preferred embodiment the perforation device is suitable and intended for producing two holes in the container. In this case it is assumed that the container Is in a rolled-up state in which two container walls or two sections of the wall are arranged one above the other. In this case it is preferably provided that the perforation device passes through both wall sections.

After the container is emptied, the first holding device preferably moves down in the apparatus. In this case it is conceivable that simultaneously a pull-off element pulls the rolled up container from the second holding device. An element which destroys the container as it is pulled down could also be integrated in this pull-off element, for instance a hook. In addition t would also be conceivable for the perforation device to be designed in the manner of a sharp blade which makes an elongate cut in the container as the first holding device moves down.

In a further advantageous embodiment would also be conceivable that a drill bit drills through the closure and the thread region of the container in order to destroy this region. In any case, however, the container should be destroyed by the perforation device.

However, in this connection it should be borne in mind that the containers are often relatively thick-walled in the mouth region, so that a perforation by means of a spike or knife may be difficult. Therefore the perforation device will preferably perforate a region of the main body which is remote from the mouth region of the container.

By the procedure according to the invention it can be ensured or guaranteed that the container can actually only be used one single, time. Therefore this container cannot be inflated again with CO₂ or refilled or used in some other way as a pressurised container. The container is irrevocably destroyed (since it is leaky) and can no longer be repaired without major expenditure. For example, simple gluing of the container cannot be stable enough in order to withstand a pressure in the container which is too high and is dangerous for the user.

In a further advantageous embodiment the perforation device is arranged on at least one of the two holding devices. The perforation device preferably has a driving device, which moves a perforation element relative to the container. Thus for example a guide element can be provided, which for instance is driven by an electric motor in order to push the perforation element through the container or through the container wall. In this case this driving device is advantageously configured in such a way that it performs a perforation only after the end of an emptying process. In this case the perforation device is also advantageously configured in such a way that the user cannot prevent the perforation of the container.

Thus, for example, under certain conditions, for instance a predefined distance between the holding devices, the perforation of the container could be triggered automatically.

In a further advantageous embodiment the driving device moves the perforation element in a direction which has at least one component which is perpendicular to a longitudinal direction of the container. Therefore in this embodiment in particular a main body of the container is punctured in particular in a direction perpendicular to the longitudinal direction. However, it would also be conceivable for the perforation to be applied in a base region of the container.

Preferably, however—as mentioned—the direction is perpendicular or oblique with respect to the direction in which the container is also compressed.

Furthermore, the present invention relates to a method for emptying containers, wherein the container is arranged between a first holding device and a second holding device and these holding devices are moved towards one another in order to compress the container arranged between these holding devices, and wherein at least at times during this compression operation liquid is removed from the container via the mouth thereof, and thus this container is at least partially emptied.

According to the invention at least one wall section of the container is perforated during or after the emptying process.

This wall section is preferably perforated in order to make the container unusable. The wall section of the container is preferably perforated after the emptying of the container.

In a further preferred method a closure of the container is also perforated, in order to empty this, more precisely, in order to produce a fluid connection to the container. For this purpose a piercing needle is preferably introduced through the closure into the container.

In a further advantageous method the wall section is perforated by a mechanical perforation element. This perforation element is preferably advanced in the direction of the wall section and passes through this. In a further preferred method it is possible for this perforation to take place automatically. This means that the user preferably has no influence on the perforation of the container and this perforation in any case takes place independently of any user intervention. In this way it is ensured that the user cannot prevent the perforation of the container.

In this case it is also conceivable to configure the perforation device in such a way that, in the event of this perforation device not functioning, the emptying process itself is also not possible.

In this way the hygiene safety is likewise improves, since no wanted or unwanted reuse of the container can occur.

Further advantages and embodiments are apparent from the appended drawings.

In the drawings:

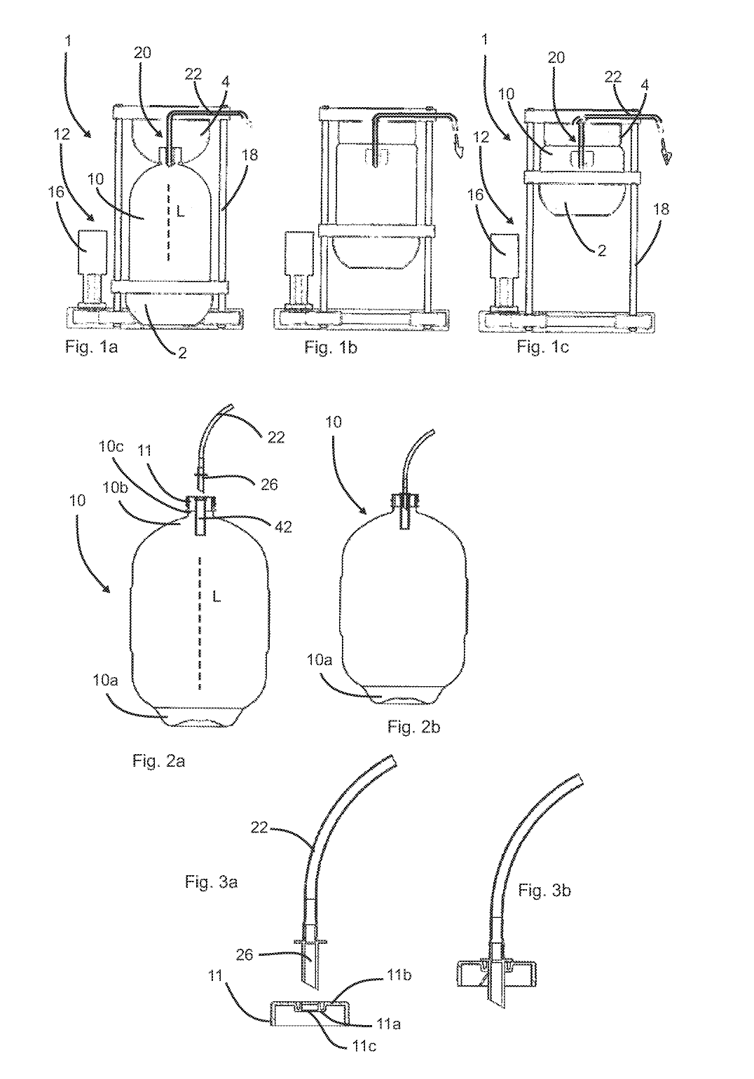

FIGS. 1a-c show an apparatus for emptying containers according to the prior art;

FIGS. 2a, 2b show two representations of containers;

FIGS. 3a, 3b show two representations to illustrate a piercing operation;

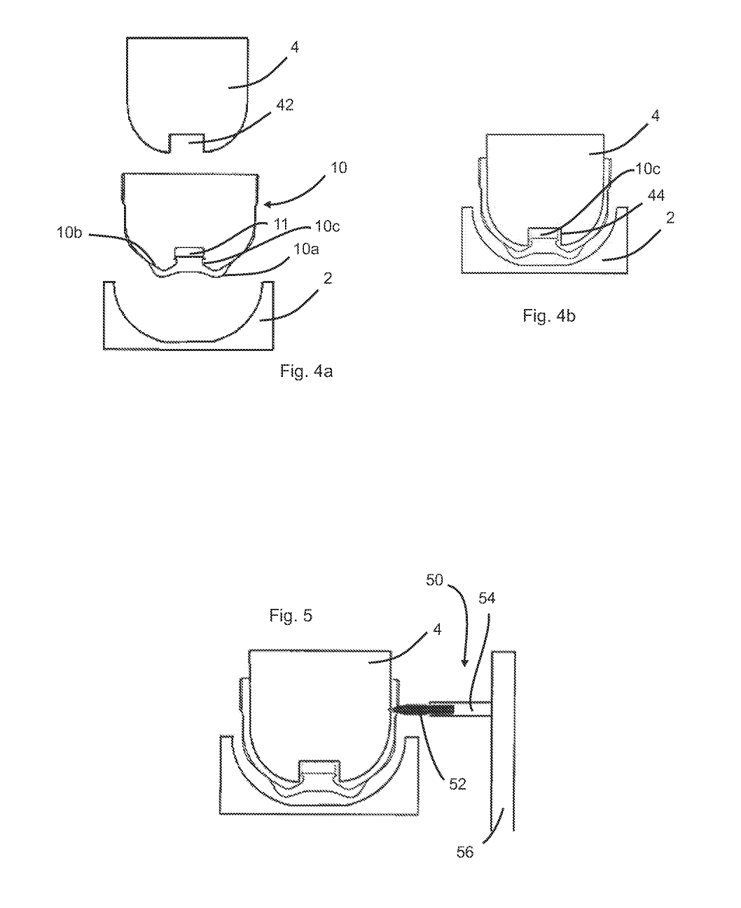

FIGS. 4a, 4b show two representations to illustrate the mode of operation of an apparatus for emptying the containers;

FIG. 5 shows an apparatus for emptying containers with a perforation device;

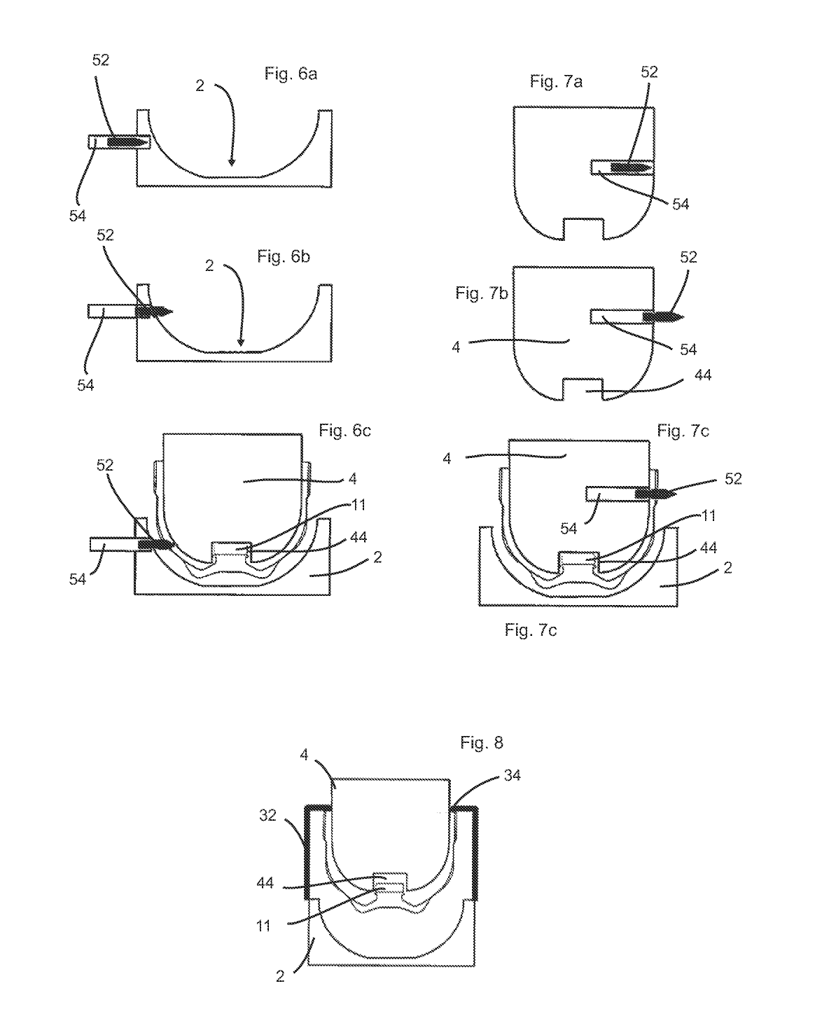

FIG. 6a-6c show a representation of a first embodiment of the present invention;

FIG. 7a-7c show a representation of a further embodiment of the present invention; and

FIG. 8 shows a further representation of an embodiment according to the invention.

FIGS. 1a to 1c show three representations of an apparatus 1 for emptying containers. In this case FIGS. 1a-1c show three positions of the apparatus 1 in different states of compression or emptying of the apparatus. For better clarity the references have only been added in the left and right part-figures. The apparatus 1 has a first holding device 2 which is suitable and intended for receiving a base region of the container 10 to be compressed.

The reference 4 designates a second holding device which in this case is designed as a die, and which is suitable for receiving a second region of the container 10, in particular a mouth region. In operation the first holding device 2 is advanced towards the second holding device 4 (i.e. moved upwards in this case), in order thus to compress the container 10 and to press the liquid, for example water, from the container.

The reference numeral 20 designates as a whole a removal device which serves for withdrawal of the liquid from the container. This removing device has inter alia a removal line 22 by means of which the liquid is removed.

The reference 12 designates an advancing device which serves to advance the first holding device 2 to the second holding device 4. This advancing device 12 has a driving device 16, such as an electric motor, which can for example drive a spindle 18 which in this way brings about an advance of the first holding device in the direction of the second holding device 4. In the event of the in FIG. 1b illustrated situation is the container approximately half emptied and in the event of the in FIG. 1c Illustrated situation is the container extensive compressed and so that even extensive emptied. The reference L designates a longitudinal direction of the container along which the container is compressed. The container is in particular a plastic container.

FIGS. 2a and 2b show two representations of containers 10. These containers have a base region 10a which is received by the first holding device 2. The reference 10b relates to a mouth region of the mouth 10c. The container is closed by a closure 11. A piercing device 26 arranged on the removal line 22 is pushed for withdrawal of liquid through a region of the closure 11. The reference 42 designates a guiding device for guiding this removal device 26.

FIGS. 3a and 3b show a detailed representation of this piercing device 26. It will be seen that this piercing device can penetrate a region 11c of the closure 11. The closure 11 is advantageously constructed in two parts and has a more stable element 11b, as well as a more flexible element 11a, also contains the surface 11c which serves for piercing. FIG. 3b shows a corresponding closure with the piercing device 26 already introduced.

FIGS. 4a and 4b again illustrates the principle of the present invention. In this case again in FIG. 4a a container 10 is shown which, however, is already in a folded-together or compressed state. This container 10 has a base region 10a, a mouth region 10b, a mouth 10c, and a closure 11. The second holding device 4 is adapted in such a way that the container—as mentioned above—can be emptied or folded together in an ideal manner.

FIG. 4b illustrates this state. In this case the container is received precisely between the two holding devices 2 and 4, wherein the second holding device 4 also has a recess 44 to receive the mouth region of the container. Inside the second holding device 4 a piercing device (not shown) for piercing the container closure 11 can be provided.

FIG. 5 shows a first embodiment of the invention. In this case it is possible again to see the structure shown in FIGS. 4a and 4b, wherein the container is arranged between the two holding devices 2 and 4. In this embodiment a perforation element 52 is arranged by means of a guiding device 54 on a (stationary) support 56. As soon as the container is completely emptied, the perforation element 52 can move out and penetrate the vessel wall. Thus the perforation element 52 here is in the form of a spike, a blade or a drill bit arranged laterally on the arm 56. The hole introduced into the container prevents a refilling or expansion of the container. The reference 60 relates to the perforation device as a whole.

FIGS. 6a-6c show a further embodiment of the invention. In this embodiment the perforation element 52 together with the guiding device 54 are integrated into the base part or the first holding device 2. As soon as (cf. Figure c) the container is completely compressed, here too the perforation element 52 will penetrate the container wall (cf. FIG. 6c).

In this case the now rolled-in container is still located on the second holding device 4. The perforation element 52 here is pressed or rotated through the vessel wall in order to destroy the container 10. Thus the perforation element 52 here is arranged in the base cup. Ideally the perforation element creates two holes, since it pierces through the double wall of the (rolled-in) container.

FIGS. 7a-c show a further embodiment of the present invention. In this embodiment the perforation element is integrated into the second holding device 4, i.e. the die. As shown in FIG. 7c, here again the container is arranged on the second holding device 4, but the perforation element acts outwards and so penetrates the container wall. Here again the guiding device 54 is illustrated which supports the perforation element.

Furthermore, the apparatus could have trigger means (not shown), which automatically implement or initiate a perforation of the container when the two holding devices 2 and 4 are arranged close to one another in the manner illustrated in FIG. 7c.

FIG. 8 shows a further embodiment of the present invention. In this embodiment the perforation is implement during removal of the container from the second holding device 4 or the die. After the container 10 is emptied, the tap system moves down the base cup 2. Simultaneously the hook 32 illustrated in FIG. 8 pulls the container from the die or the second holding device 4. A perforation element 34, which destroys the container as it is pulled down could also be integrated in this hook. In addition it would also be conceivable that a sharp blade makes an elongate cut in the container as the base cup moves down.

Furthermore it would also be possible that this cutting is also used in order to release the container more easily from the second holding device 4. In this case it would be conceivable that this cut is complete and thus after penetration of the cut the container can be more easily removed from the second holding device 4. In this case it would be conceivable that a groove which co-operates with such a blade or into which this blade can enter is provided in particular so that it runs in a straight line in the longitudinal direction in the holding device on the outer perimeter thereof. In this way a cut could be produced more easily in the container wall.

In addition—in contrast to what is shown in the drawings—it would also be conceivable that a drill bit drills through the closure and the thread region of the container in order to destroy this region.

The applicant reserves the right to claim all the features disclosed in the application documents as essential to the invention in so far as they are individually or in combination novel over the prior art. Furthermore it is pointed out that features which may be advantageous per se have also been described in the individual drawings. The person skilled in the art recognises immediately that a specific feature described in a drawing may also be advantageous without the incorporation of further features from this drawing. Furthermore the person skilled in the art recognises that advantages may also result from a combination of several features shown in individual drawings or in different drawings.

### LIST OF REFERENCES

1 apparatus
2 first holding device
4 second holding device
10 container to be compressed
10a base region
10b mouth region
10c mouth
11 closure
11a more flexible element of the closure
11b more stable element of the closure
11c region of the closure
12 advancing device
16 driving device
18 spindle
20 removing device
22 removal line/liquid pipe
26 piercing device
32 hook
34 perforation element
42 guiding device
44 recess
50 perforation device
52 perforation element
54 guiding device
56 support
L longitudinal direction of the container

1. Apparatus for emptying containers and in particular plastic containers with a first holding device which is suitable and intended for holding a first section of the container, with a second holding device which is suitable and intended for holding a second section of the container, wherein the first holding device and the second holding device are movable with respect to one another in order to compress the container located between these holding devices, and with a removal device in order to remove liquid from the container via a mouth thereof, wherein the apparatus has a perforation device which perforates at least one wall region of the container.

2. Apparatus according to claim 1, wherein the apparatus has a piercing device in order to puncture a container closure arranged on the container.

3. Apparatus according to claim 1, wherein the perforation device has a mechanical perforation element which punctures a wall of the container.

4. Apparatus according to claim 1, wherein the first retaining device receives a base section of the container and/or the second holding device receives a mouth region of the container.

5. Apparatus according to claim 1, wherein the perforation device is arranged on at least one of the two holding devices.

6. Apparatus according to claim 1, wherein the perforation device has a driving device which moves the perforation element relative to the container.

7. Apparatus according to claim 6, wherein the driving device moves the perforation element in a direction which has at least a component which is perpendicular to a longitudinal direction of the container.

8. Method for emptying containers, wherein the container is arranged between a first holding device and a second holding device and these holding devices are moved towards one another in order to compress the container arranged between these holding devices, and wherein at least at times during this compression operation liquid is removed from the container via the mouth thereof, and thus this container is at least partially emptied, wherein during or after the emptying process at least one wall section of the container is perforated.

9. Method according to claim 8, wherein the wall section is perforated by a mechanical perforation element.

10. Method according to claim 8, wherein the perforation of the container takes place automatically.
